(19) United States
(12) Patent Application Publication
(10) Pub. No.: US 2009/0134238 A1
(43) Pub. Date: May 28, 2009

(54) Reservoir and matrix system for controlled release of insect semiochemicals

(75) Inventor: James Douglas Watts, Calgary (CA)

Correspondence Address: Mr. Jim Watts, 3155 Upper Place N.W., Calgary, AB, T2N 4H2, CA

(73) Assignee: Biosect Research Ltd.

(21) Appl. No.: 11/452,074

(22) Filed: Jun. 13, 2006

(51) Int. Cl. A24F 25/00; A01N 63/04

(52) U.S. Cl. 239/44; 424/405

(57) ABSTRACT

An integrated reservoir and controlled release matrix system (1) for the controlled release of insect semiochemicals is described. The system includes a reservoir (2) possessing a volume chamber and sealed vent opening (5) at one end. Extending from the opposite end of the reservoir chamber is a hollow needle-like conduit (7) which is open to the reservoir chamber at one end. The conduit protrudes or extends from the reservoir and impregnates a release matrix (3), effectively connecting the reservoir with the release matrix. The conduit may be variously formed with: a) an opening at the reservoir end which is open to the reservoir chamber and only one opening at the opposing end protruding into the release matrix; or b) multiple perforations along its length accompanying the end opening into the release matrix; or c) multiple lengthwise perforations without an end opening into the release matrix. The release matrix is also variously formed of elongated cubic or spherical geometry. The system is activated by simply removing the vent opening seal, or inserting a hollow or solid valve stem or wick into the reservoir vent opening.

### REFERENCES

U.S. Patent Documents
U.S. Pat. No. 4,947,578 August, 1990 Anderson and Lokkesmoe

### OTHER REFERENCES

Byers, J. A. 1988b. Novel diffusion-dilution method for release of semiochemicals: Testing pheromone component ratios on western pine beetle. J. of Chemical Ecology. 14: 199-212.
Fuganti, C. and P. Grasselli. 1985. Stereochemistry and synthetic application of products of fermentation of alpha, beta-unsaturated aromatic aldehydes by baker's yeast. Ciba Foundation Symposium. 111: 112-127.
Hassanali, A. et. al. 1989. Humidity effects on response of Argas persicus (Oken) to guanine, an assembly pheromone of ticks. J. of Chemical Ecology. 15: 791-797.

### FIELD OF THE INVENTION

This invention relates to a reservoir and accompanying matrix system for the controlled release of liquid and/or soluable particulate volatiles as insect semiochemicals. Specifically, these components comprise a release system for enhancing volatization of insect semiochemical compounds acting as attractants or repellents on different insect families; principally, but not limited to, filth flies and mosquitoes of the families Muscidea, Sarcophagidae, Calliphoridae, and Culicidea. The semiochemical compounds are released as volatiles at a controlled rate, acting as attractants or repellents of insect pests. The compounds are sealed within the affixed reservoir, enabling the release rate to remain relatively constant and effective until the semiochemical compound is evaporated.

### BACKGROUND OF THE INVENTION

A plethora of insect semiochemicals acting as attractants, repellents, or otherwise modulators of insect behavior have been discovered, described, and disclosed in patent art. These compounds and materials are various in nature, acting as volatile vapors themselves, or particulate materials volatized by means of volatizing media given off into the atmosphere. These materials then modulate insect behavior, acting as attractants, repellents, or other chemical messengers.

These volatile constituents comprise numerous chemical families, and act concertedly and often synergistically; the individual component compounds often acting at differential release rates as a function of concentration in the volatizing mixture. Controlled release systems or devices volatizing insect semiochemicals into the atmosphere through membranous control media make limited use of these differential release rates and can serve to restrict the release rate associated with some of the volatile components. Further, compensating for this by increasing porosity of the controlling media can exaggerate the release rate of other volatile components within the mixture, compromising or rendering the semiochemical material ineffective. No effective and successful controlled release system or device that continually and inherently accounts or compensates for these differential release rates of volatile components has been developed in the prior art.

Many prior and current systems for semiochemical release have made use of dispensing highly volatile compounds such as pheromones from impregnated plastic or cellulose materials. While effective absorbents and effluents, these impregnated materials are subject to limiting influences of temperature and atmospheric pressure, thus creating inconsistent and differential release of the release material itself. This further results in an ineffective and inconsistent useful life of the system.

Other release systems have attempted to overcome this deficit by incorporating a limiting membrane with a reservoir containing the liquid material to be released. Membrane materials are typically impermeable to the liquid phase, and thus allow volatiles given off from the liquid to pass into the atmosphere. These systems are subject to the constraints of pore size and permeability noted above. As well, these designs fail to account for the mitigating effects of temperature and pressure on semiochemical action. Arthropods exhibit differential responses to semiochemical dose rates, these responses being mediated by temperature or humidity. Thus, a release system utilizing the properties of an impregnable matrix in conjunction with a reservoir containing the release material provides for a more constant and continual release rate for the duration of operating time of the device. Further, the release matrix composition and surface area are significant in compensating for the effects of temperature and pressure on both the overall release rate as well as variations in volatile concentrations comprising the release mixture as given off into the atmosphere.

### SUMMARY OF THE INVENTION

This invention provides for an improved system of controlled semiochemical release. This system incorporates a reservoir for the containment of the semiochemical material which operates in conjunction with a release matrix composed of an integration of cellulose or other material bound by plastic polymer. The reservoir and release matrix are affixed such that the release material is able to flow into and occupy the entire available volume and surface area of the release matrix. The composition ratio and surface area of the release matrix are altered in order to accommodate the nature of the material to be released. An exposed surface area allows for effective concentrations of material to be released at relatively constant rates in order to elicit a response from a greater proportion of a flying insect pest population. These properties serve to maintain an optimal release rate and concentration composition until the entire capacity of the reservoir is dispensed. The release matrix composition and surface area therefore serve as an environmental buffer, allowing release material to collect at required concentration levels with respect to the material components while exposed to environmental conditions. The surface area properties allow for a greater dispersal and volume of material to be given off at required concentrations and release rates while minimizing extremes in volatization caused by environmental conditions.

### DETAILED DESCRIPTION OF THE INVENTION

The reservoir and release matrix system can be sized and configured to work with any flying insect trap container or apparatus. The reservoir container design uses a cylindrical shape in order to conform to various enclosure types and maintain a sufficient volume of semiochemical material. The cylindrical shape also facilitates a gravity feed function of the material from the reservoir into the release matrix; the top or upper end of the reservoir being vented to allow atmospheric air to occupy the reservoir as semiochemical material is consumed. The area opening of this vent to the atmosphere regulates the rate of dispension of semiochemical into the release matrix, thus controlling optimal concentrations, ratios, and the overall release rate of semiochemical components into the environment.

The reservoir container can be composed of any non-corrosive material that will not react with or contaminate the reservoir contents. High density, thermoplastic polymers such as Nalgene¹ are ideal to form the reservoir as these materials are essentially inert and non-reactive to the vast majority synthetic insect semiochemical compounds, as well as solvents. As indicated, the overall release rate of the device is regulated by the exposed area of the reservoir vent operating under a given atmospheric temperature and pressure in conjunction with the density and material composition of the release matrix. ¹ ®Registered Trademark of Nalge Nunc International

These properties define the operating life of the system and are adjustable according to the reservoir capacity in order to achieve optimal release rates and operating time frames at a given ambient temperature. A standard reservoir capacity of 10 to 12 ml of semiochemical material would provide an operating lifetime of three to six weeks at indoor room temperature (˜20°), depending on the composition of the semiochemical material. Larger reservoir capacities in addition to utilization of a hollow or solid valve stem within the exposed reservoir vent can extend the operating life of the device. The properties and capacity can be configured to achieve optimal release rates over an operating life of several months, depending on: the insect pest composition; trap container size; semiochemical composition; release matrix composition and exposed surface area; and conditions of the operating environment. For a given semiochemical composition, the release rate will increase in proportion to ambient temperature, release matrix composition and density, and exposed surface area of the release matrix. The total effective volume of semiochemical material given off, and the resulting affected control area, is a function of exposed surface area of the release matrix. The properties of matrix composition and density, and release matrix surface area combine somewhat to produce overall release rate and release volume behavior. This is depicted in FIG. 3.

The release matrix may be composed of any of an array of polymeric compounds; including polymers, copolymers and terapolymers of vinyls, esters, ethylenes, xylanes, xylenes, propylenes, urethanes, urethenes, nylon compounds, silicon compounds, nitrogenous compounds, as well as various rubbers and elastomers. These compounds can be combined at different ratios with each other and cellulose to achieve desired release rates and properties. The majority of our matrix trials have been accomplished using various densities of ethylene vinyl acetate as the principal binding polymer.

Critical to particular dipterous insect pests, the release matrix density is modifiable with cellulose and the absorption binding polymer to achieve a loose, breathable matrix in order to accommodate a given amount of baker's yeast as forming part of the matrix composition. In this manner, the release matrix simulates a living, respiring system where the matrix density allows for macromolecular permeation by such compounds as aqueous polysaccharides such as glucose in order to activate fermentation of the baker's yeast, thus producing and eluting the complex volatile alcohols and methyl diols of fermentation in combination with other volatiles of the semiochemical material as a consequence of the release matrix being permeated by the components of the semiochemical material. This property and phenomenon precludes the requirement of concentrated alcohols as components of the original semiochemical material, thus eliminating the associated problems of flamability.

A vast array of semiochemical compositions can be used with the system. Our trials have been confined to dipterous and hymenopterous pest species, however semiochemical compositions can be utilized in order to also act on and modulate populations of Lepidoptera, Homoptera, Hemiptera, Coleoptera, etc. As well, the modulation can act on a predatory or parasitic population, depending on the insect species and semiochemical composition. Further, the affected insect population is then able to be manipulated in order to exert control (via trapping out, attract-and-kill methods, capture-and-release methods, etc.), monitor population parameters, induce biocontrol on an arthropod pest population via augmentative or conservative means, etc.

This invention can be conformed such that the properties of the device in conjunction with the semiochemical composition are able to operate indoors. As such, the effluent of volatiles given off remains undetectable to humans, however serving to provide effective attraction and control of indoor flying insect pests such as muscids, calliphorids, sarcophagids, drosophillids, etc. Components and semiochemical composition are also modifiable in order to operate effectively as a repellent device outdoors on insect pests such as culicids, simulids, ceratopogonids, etc. Further, the matrix properties and components can be modified in order to operate in conjunction with semiochemical compositions and trap configurations such as to act as attractant apparatus for culicids, etc.

As indicated, the device of this invention can be conformed to be used with any insect or arthropod trap. Such traps may comprise any design and technology in order to entrap, enclose, and/or dispatch of the affected arthropod population for the purposes of direct population control, attract-and-kill, attract-and-release, population monitoring, etc.

### DETAILED DESCRIPTION OF THE PREFERRED EMBODIMENT

FIGS. 1 and 2 show the reservoir and attached matrix controlled release system. FIG. 1 shows the invention itself and FIG. 2 shows the invention within an enclosure device designed to capture indoor flying insects. The system device 1 includes a cylindrical reservoir chamber 2 affixed to a release matrix 3. The upper end of the reservoir chamber is sealed with a rubber stopper or plug 4. This plug 4 contains a central hole or perforation 5 which acts as a vent allowing air to enter the reservoir as semiochemical material is dispensed. This vent is sealed with a plastic polymer fill or an adhesive barrier external cover 8, or both. The system is activated by removing the barrier cover 8 and inserting a hollow or solid valve stem pin 6 into the stopper vent 5. The reservoir cylinder 2 is affixed to the release matrix 3 by means of at least one hollow delivery needle 7 inserted directly into the core of the release matrix 3.

This comprises the useful system of the invention, and while several different configurations, geometries, and sizes of the reservoir cylinder are possible within the scope of this invention, the dimensions of the reservoir cylinder 2 as shown in FIGS. 1 and 2 are 8.3 cm in length by 1.4 cm in diameter.

As shown, the release matrix 3 is 5 cm in length by 4 cm width by 0.5 cm thickness. The affixing delivery needle 7 is 2.5 cm in length by 0.1 cm outside diameter, as pictured.

The stopper 4 fits snugly within the internal diameter of the reservoir 2, and is also cemented by means of an adhesive to ensure the integrity of the system. The stopper 4 is formed of any of a number of plastic or rubber materials so that the stopper material itself will not react with and/or contaminate the contents of the reservoir chamber. The stopper 4 is perforated completely by the vent hole 5. The vent hole 5 is circular and of a diameter of 0.15 cm, as shown. The barrier cover 8 is circular and the same diameter as the stopper 4, and is formed of impermeable coated paper or membranous plastic. It is adhesive coated and designed to seal the semiochemical material within the system 1 until the adhesive seal is broken. The barrier cover 8 is removed and the vent hole 5 is pierced or perforated by the valve stem 6 in order to activate the system 1. The barrier cover 8 is completely removed in order to use the invention.

In the preferred embodiment an adhesive glue board is used to capture flying insects. However, any means of mechanically or electrically entrapping and/or dispatching of captured material may also be used with the invention. This invention may also be used in conjunction with an ultraviolet or other light source operating as an additional attractant lure.

Operation of the invention is caused by removal of barrier cover 8 and perforating the vent hole 5 with valve stem 8. This enables air to enter the system reservoir 2 and allow semiochemical material to occupy the matrix 3 via the delivery needle 7, thus causing the release of semiochemical material from the system matrix 3. Release of semiochemical material from the system matrix 3 causes either attraction or repellency of flying insects, depending on the nature of the semiochemical material.

As noted, the enclosure shape, dimensions and configuration, and combination of materials comprising the system may be altered to suit the operating environment, arthropod system, and preferred results. As given in the preferred embodiment and shown in FIG. 2, the entrapment enclosure is equipped with side air vents on both sides of its width. These allow for air flow through the device enclosure, thus facilitating the release of semiochemical from the release matrix. The device enclosure is also equipped for two release matrices, one on each interior side next to the air vents. This permits a synergistic affect of semiochemical combinations which cannot be mixed within a single release reservoir. Further, should the operating environment warrant, air vents may be present within the front panel or surface of the enclosure to further enhance air flow and semiochemical release. As well, within the preferred embodiment, the entrapment enclosure is formed of two separate pieces which are assembled to attain the enclosure configuration and are easily disassembled to allow for cleaning, reloading, and other maintenance of the device. The two pieces of the enclosure also assemble so as to provide for an open top to the enclosure which allows flying insects to enter. This also allows for quick and easy replacement of the adhesive glueboard.

### DESCRIPTION OF DRAWINGS ACCOMPANYING RESERVOIR AND ATTRACTANT MATRIX SYSTEM FOR CONTROLLED RELEASE OF INSECT SEMIOCHEMICALS

FIG. 1.

This drawing shows the invention itself. The reservoir containing the semiochemical material for release is shown as item 2. It is connected to the release matrix, item 3. The release matrix is angled at approximately 45° in order to increase airflow around the entire surface area of the release matrix. The reservoir is sealed and vented as indicated to allow the material to flow into the release matrix for controlled evaporation.

FIG. 2.

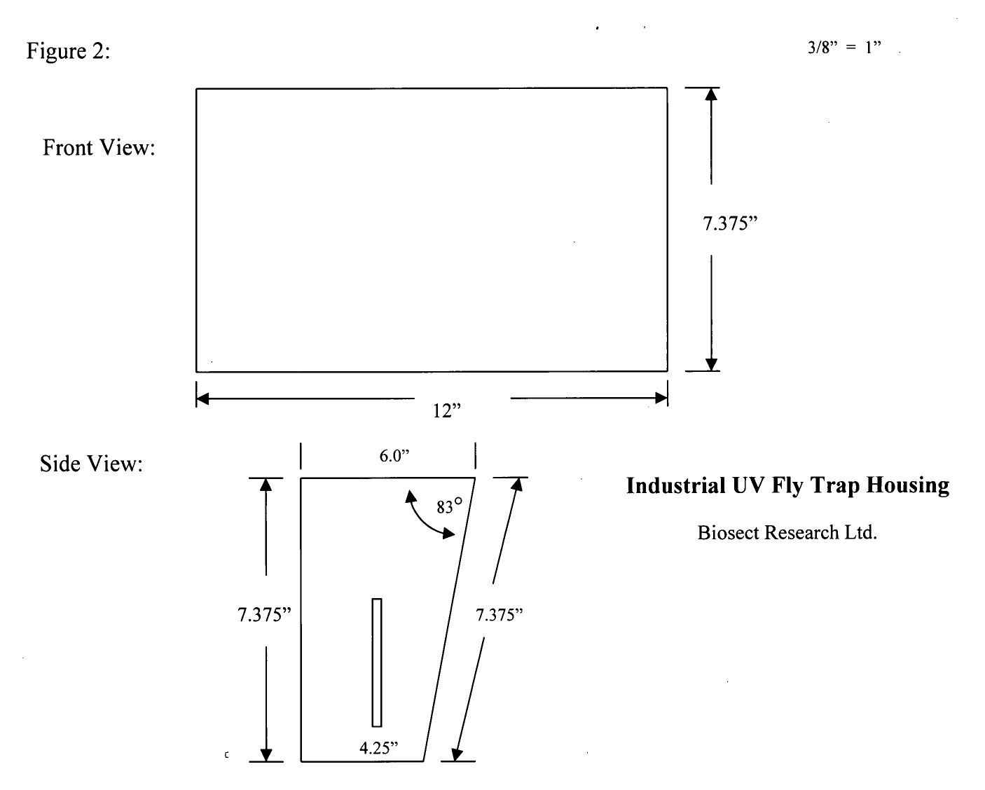

This drawing shows a preferred trap housing designed to enclose the invention. The front view gives the rectangular dimensions of the trap and the side view shows the trapezoidal and angular dimensions as well as the side vents to allow for air flow through the trap housing.

FIG. 3.

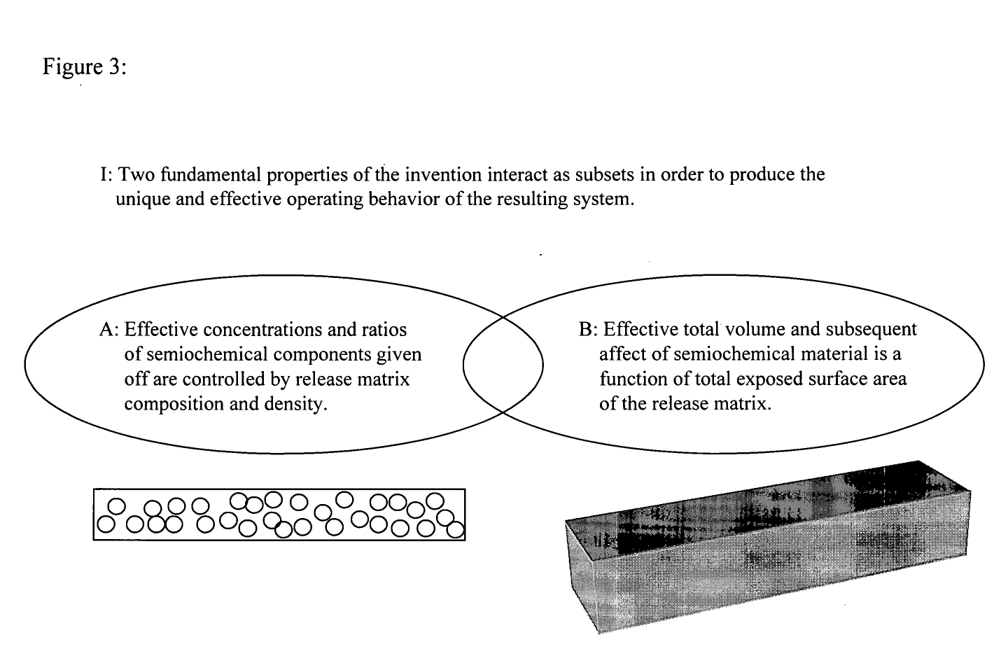

This drawing provides a visual representation of two interacting properties of the release matrix. Part A depicts matrix composition and density and part B demonstrates total exposed surface area of the release matrix.

In association with the embodiment of the invention:

1. An integrated reservoir and matrix system for release of insect semiochemicals comprising a) a fixed volume reservoir for containment of insect semiochemical material affixed by means of b) a hollow conduit or needle-like connection from the reservoir and directly impregnating c) a polymer/cellulose binding matrix providing for containment, regulation, and release of the semiochemical material into the atmosphere.

2. The system of claim 1, such that the reservoir contains an opening vent of various diameter.

3. The system of claim 1, containing a release matrix of various constituent and porous density.

4. The system of claim 3, such that the density and exposed surface area of the release matrix are varied by means of constituent materials, constituent or component ratios, and matrix dimensions in order to provide for a stable release rate in conjunction with the diameter of the reservoir vent opening and the diameter of the connecting conduit; the release matrix being generally formed of an elongated cubic or spherical shape in order to achieve said surface area.

5. The system of claim 3, such that the release matrix density and porosity is varied by means of constituents and constituent ratios in order to accommodate various natures of semiochemical composition, including liquid and liquid-suspended particulate phases; the release matrix constituents comprise various cellulose and plastic polymer types or derivatives in order to provide for differential matrix density and porosity to confer stable release properties to the system.

6. The system of claim 3, such that the release matrix density is modifiable with cellulose and an absorptive polymer binding material in order to achieve a breathable matrix composition to accommodate baker's yeast or other synergistic components as integral forms of the matrix composition.

7. The system of claim 1, such that the connecting conduit affixing the release matrix with the reservoir is hollow to allow for a liquid flow rate and is open at both ends, or is otherwise closed at the end protruding into the release matrix and is alternatively open to the release matrix by means of one or multiple perforations along the conduit length; multiple perforations being positioned in opposed manner, symmetrical or otherwise, along the conduit length accessing the matrix interior.

8. The system of claim 1, such that the release matrix is otherwise affixed to the reservoir and impregnated by multiple connecting conduits in order to facilitate equivalent or balanced occupation of the reservoir volume by the semiochemical material.

9. The system of claim 1, such that the reservoir is cylindrical, possessing a length of 8 to 12 cm and a diameter of 1 to 3 cm.

10. The system of claim 7, such that the connecting conduit or needle is 2 to 4 cm in length and 0.1 to 0.4 cm outside diameter.

11. The system of claim 7, such that the connecting conduit or needle is straight in geometry conferring an angle of 180° to the entire system, or is otherwise bent to confer an angle of greater than 180° but less than 270° to the entire system.

12. The system of claim 2, such that the reservoir opening vent possesses a diameter ranging from 0.1 to 0.25 cm.

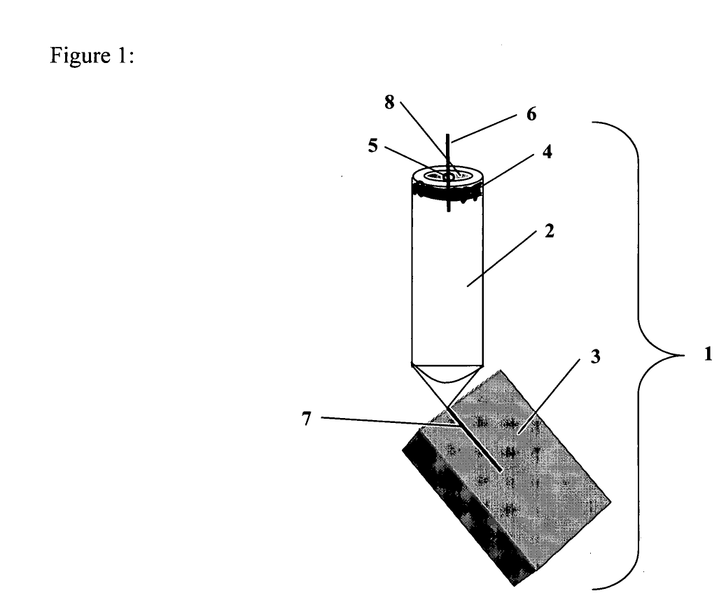

13. The system of claim 1, such that the reservoir vent opening may be occupied by a hollow or solid valve stem as shown in FIG. 1 or, alternatively, a cotton/cellulose wick; the wick being exposed externally to the atmosphere while in contact with the reservoir contents.
